(19) United States
(12) Patent Application Publication
(10) Pub. No.: US 2020/0317202 A1
(43) Pub. Date: Oct. 8, 2020

(54) METHOD FOR ASCERTAINING A LIQUID DEPTH OF A LIQUID ACCUMULATION ON A TRAVEL PATH IN FRONT OF A VEHICLE, AND METHOD FOR ASCERTAINING A TRAVEL TRAJECTORY THROUGH A LIQUID ACCUMULATION ON A TRAVEL PATH IN FRONT OF A VEHICLE

(71) Applicant: Robert Bosch GmbH, Stuttgart (DE)

(72) Inventors: Elmar Staudacher, Esslingen (DE); Udo Schulz, Vaihingen/Enz (DE)

(21) Appl. No.: 16/838,454

(22) Filed: Apr. 2, 2020

(30) Foreign Application Priority Data
Apr. 8, 2019 (DE) 102019205023.9

(51) Int. Cl. B60W 40/06; B60W 10/20; B60W 30/095; B60W 30/09; B60W 10/04; B60W 10/18

(52) U.S. Cl. CPC B60W 40/06; B60W 10/20; B60W 30/095; B60W 30/09; B60W 10/04; B60W 2050/0077; B60W 2420/42; B60W 2552/15; B60W 2555/20; B60W 2520/16; B60W 2520/18; B60W 10/18

(57) ABSTRACT

A method for ascertaining a liquid depth of a liquid accumulation on a travel path of a vehicle, in particular in front of a vehicle. The method comprises the following steps: reading in a current image of a vehicle-external region of the travel path, detected by an image detection device in particular of the vehicle, in which a detected liquid accumulation is present, and ascertaining the liquid depth of the liquid accumulation by comparing the current image with an image that is stored in a storage device and represents the vehicle-external region without a liquid accumulation.

### CROSS REFERENCE

The present application claims the benefit under 35 U.S.C. § 119 of German Patent Application No. DE 102019205023.9 filed on Apr. 8, 2019, which is expressly incorporated herein by reference in its entirety.

### FIELD

The present invention relates to a method for ascertaining a liquid depth of a liquid accumulation on a travel path in front of a vehicle, and a method for ascertaining a travel trajectory through a liquid accumulation on a travel path in front of a vehicle. A further subject of the present invention is a computer program.

### BACKGROUND INFORMATION

German Patent Application No. DE 10 2017 010 746 A1 describes an evasion method for a vehicle.

### SUMMARY

In accordance with the present invention, an example method, an example control device that uses the method, and an corresponding example computer program, are provided. Advantageous refinements of and improvements to the example method, example control device, and example computer program according to the present invention are described herein.

In accordance with the present invention, advantageously, a liquid depth of a liquid accumulation on a travel path of a vehicle, in particular in front of a vehicle, is ascertained, so that a hazard resulting from the liquid accumulation when driving through it can be identified promptly.

An example method in accordance with the present invention is provided for ascertaining a liquid depth of a liquid accumulation on a travel path of a vehicle, in particular in a travel direction of the vehicle in front of the vehicle. The example method encompasses a reading-in step, a comparing step, and an ascertaining step. In the reading-in step, a current image of a vehicle-external region of the vehicle, detected by an image detection device in particular of the vehicle, is read in, an identified liquid accumulation being present in said image. In the comparing step, the current image is compared with an image stored in a storage device. The stored image can represent a vehicle-external region having no liquid accumulation. In the ascertaining step, the liquid depth of the liquid accumulation is ascertained based on a comparison result of the comparison that has been carried out. The comparison result can represent a liquid depth of the liquid accumulation.

A “liquid accumulation” can refer, for example, to a puddle that is only a few centimeters deep, but also to a road inundation, a ford, or even a small lake. The liquid accumulation can accordingly become an obstacle for the vehicle on the travel path. The vehicle can be configured, for example, to transport persons and, additionally or alternatively, objects. The travel path can proceed over a road, but also beyond paved roadways. The current image can represent an external region of the vehicle which was detected, for example, using a camera and/or LIDAR. In that context, a liquid accumulation was identified in the external environment of the vehicle. This can occur, for example, in the image detection device, which is embodied, e.g., as a camera, or in an image evaluation device. The liquid accumulation can be identified, for example, by the fact that a region in the surroundings of the vehicle exhibits high planarity and/or inflection points at the edge region of the regions identified as a liquid accumulation. This results from the fact that liquid accumulations have a very flat surface, and that inflection points with respect to the adjacent surroundings, constituting “banks,” are present at the edge region. Such inflection points can often also not have a highly curved or bent profile, in contrast to roadway edges which usually proceed in very straight fashion over a longer portion. It is also possible for a liquid accumulation to be identifiable by way of a reflective surface or objects reflecting in the surface of the liquid accumulation, especially if images of a camera are being evaluated. An evaluation of the polarization of light from the region in which a liquid accumulation is suspected can also give an indication as to the presence of the liquid accumulation, since light usually experiences a change in polarization direction when reflected from the surface of a liquid accumulation.

A “stored image” can be understood as an image of a camera or of a LIDAR sensor which was acquired at a previous point in time.

Three-dimensional camera- or LIDAR-based three-dimensional surroundings representation maps, which are also used in SLAM video in robotics, are used, for example, for this purpose. In that context, the extracted features, and furthermore even classified objects, from many images and from various camera perspectives over journeys previously taken over that route are fused into a three-dimensional map (semantic map). The latter can optionally also reference GNSS. In the context of vehicle localization and navigation, the current position and orientation of the camera, and thus of the vehicle, in that map is ascertained using such surroundings representation maps.

A “classified object” or an “object class” is, for example, a liquid accumulation or puddle. Classification is performed, for example, using machine vision methods.

A “semantic map” contains predominantly objects classified by machine vision, for example a person, puddle, vehicle, house, etc., on a terrain that has been surveyed in three dimensions and is identified as freely travelable.

It is also possible, however, for the “stored image” to be understood as a datum from a digital map that contains a datum regarding a location of the bottom beneath the liquid accumulation, for example a geodetic elevation of that bottom, from which in turn, together with the information from the current image, a liquid depth of the liquid accumulation can be ascertained.

The liquid depth can be ascertained, for example, by way of a difference between an elevation of the travel path in front of the vehicle (i.e., for example, the location or elevation of the surface of the liquid accumulation) from the current image, and the elevation of the travel path in front of the vehicle from the stored image (which is then interpreted, for example without a liquid accumulation, as a solid bottom of the liquid accumulation or one that can be traveled by the vehicle).

This three-dimensional surroundings representation map without a liquid accumulation can also be generated gradually using constantly new images, by the fact that the images or image parts having the lowest liquid level, or preferably with no liquid level, are always used for the fusion of features and/or objects in that map. Over time, a surroundings representation map having no puddles would result, or ordinary bodies of water at their lowest level would be identified. Ordinary bodies of water are entered on topological maps and can thus represent the initial (or “null”) level (reference map).

When a “stored image” is discussed here, what is meant thereby, corresponding to the current position and orientation of the camera on the vehicle in the stored surroundings representation map, is the pertinent image from the stored surroundings representation map. This is then compared with the current image from the camera.

It is also useful to store such memory-intensive surroundings representation maps on servers or in the cloud, and to download only partial maps corresponding to the current position and orientation of the camera.

The server or cloud approach in accordance with the present invention is particularly advantageous if several vehicles, with their cameras, are using such surroundings representation maps and contributing to the updating thereof. Fusion of images in a shared or identical environment can then take place on the server or in the cloud.

In addition to the surroundings representation map without puddles (also called a “reference map”), it is optionally also possible to prepare a current surroundings representation map (or “current map”). For this, it is useful to store the up-to-dateness of the identified features and objects (e.g., puddles) with a date and/or confidence value. Route plans or trajectory plans having a wider horizon can thereby be prepared.

Instead of a three-dimensional map, it is also possible to imagine a semantic two-dimensional map into which the topology (terrain elevations and puddle elevations) are then entered on a specific grid. The camera should then identify/classify and localize the objects (e.g., puddles, prominent or stationary objects in the surroundings) and enter them in the current two-dimensional map (terrain map). If the position and orientation of the camera in the map is known, and if the object and its position in the map are determined, the direct image comparison is then not necessary. This means that, for example, in principle only surface profile elevations at a specific position on the map are compared. In other words, for example, where currently a puddle and its elevation are identified, the previous elevation without liquid is subtracted from the reference map at the location of the current object (=puddle) and the puddle depth is thus ascertained. The reference map or grid map can be constructed like a table, and fields can contain the elevation without liquid. The camera identifies the puddle as such, and the position or extent, and the current elevations in general, in the terrain. The puddle depth can be ascertained by subtraction of the values. The construction of the current map would be similar, except that then the information entered into the table fields is where or at what point the puddle extends. This would basically be an indirect image comparison, since in this case processed information from the image processing function is being compared. Localization of the vehicles or cameras, and thus, via camera image processing, of the localized objects and elevations or topology of the surroundings, can be effected with reference to surroundings features based on camera data or LIDAR data (SLAM method) and/or GNSS.

In accordance with the present invention, a liquid accumulation such as a puddle or a water-filled pothole on the road can be identified effectively by way of an ingenious evaluation of images from cameras (in most cases already installed as standard equipment) in vehicles, and the depth of the liquid accumulation can also be ascertained by way of a comparison with an image or elevation data of the road or roadway, or generally a travel path, prior to filling of the ground irregularity with liquid. The present invention provided herein can also be used beyond paved paths or roads, for example when ascertaining rainwater accumulations in ground depressions of fields or on impassable terrain. As a result, the present invention can also be used, for example, for trajectory planning for tractors on agricultural terrain or on construction sites beyond paved roads, as long as image data in which no liquid accumulation is present in the relevant ground irregularities are available for that terrain portion.

The example method can furthermore encompass a step of updating the stored image in the storage device before the comparing step, the updating step in particular being performed at least once a day, for example if cameras on the vehicles and/or in the infrastructure have acquired corresponding images.

An embodiment in accordance with the present invention in which the updating is embodied in weather-dependent fashion is possible with reference to object identification of a “puddle” object. Updating of the reference map after or during a dry period provides particular advantages here. Conversely, updating of a current map during or after rain can be useful. Rain sensors installed in vehicles are now existing art, so that data which in most cases are already available offer an additional benefit and contribute, with their information, to the ascertainment of weather maps or rain maps.

A current version of the stored image and/or of the reference map on the storage device (vehicle and/or server and/or cloud) can be stored as a result of the updating step so that, advantageously, changes in the region in front of the vehicle, for example road construction or a change in the ground irregularity on the travel path, can be identified promptly and, according to an example embodiment of the present invention, a datum containing it can be used in order to ascertain the liquid depth. By taking contemporaneously detected parameters into consideration, it is thereby possible to ascertain a current liquid depth very precisely.

The example method in accordance with the present invention is one in which, in the comparing step, a comparison is carried out between an identified topographic elevation of the travel path and/or a liquid accumulation surface from the current image, and an identified topographic elevation of the travel path and/or of a liquid accumulation surface from the stored image, in order to ascertain the liquid depth. Advantageously, a liquid depth can thereby be determined very precisely and with simple means, thereby creating the possibility of reducing a risk of damage to the vehicle.

According to an embodiment, in the comparing step, a depth profile of the travel path in the region of the liquid accumulation can be ascertained. The depth profile of the travel path can be also be referred to, for example, as a “bottom contour.” For example, the depth profile can represent a spatial profile of the liquid depth in one spatial direction or in two spatial directions. A precise representation of the subsurface on which the vehicle can move can thereby be ascertained, constituting, for example, a very good initial basis for determining a travel trajectory through the liquid accumulation.

The example method according to the present invention can further encompass a step of furnishing an indication signal, to be outputted to an indicating device in particular of the vehicle, which represents an ascertained liquid depth of the liquid accumulation and/or a subsurface contour beneath a liquid accumulation surface. The indicating device can be implemented, for example, as a (for example, also touch-sensitive) display by way of which information can be indicated to a user of the vehicle. A vehicle occupant can thereby be given an opportunity to get an idea of the depth of the liquid accumulation in front of the vehicle, so that that information can helpfully be used, for example, when manually selecting the travel route through the liquid accumulation.

An example method according to the present invention for ascertaining a travel trajectory through a liquid accumulation on a travel path in front of a vehicle is also presented. The example method encompasses the steps of a method, described above in variants, for ascertaining a liquid depth of a liquid accumulation on a travel path in front of a vehicle, and a step of ascertaining the travel trajectory of the vehicle, which represents a travel route through the liquid accumulation, using the ascertained liquid depth of the liquid accumulation.

The “travel trajectory” refers to a route or a planned driving path through the liquid accumulation (for example, a water accumulation). Advantageously, it can thereby be made possible for a user to drive safely through the water accumulation with no risk, for example, of unnecessarily damaging the vehicle or having the vehicle become stuck.

According to an embodiment of the present invention, the method can have a step of detecting at least one rolling motion and, additionally or alternatively, a pitching motion of the vehicle, in order to plausibilize the liquid depth of the liquid accumulation and, additionally or alternatively, to redetermine it, the pitching motion and, additionally or alternatively, the rolling motion in particular being detected by an image detection device and/or an inertial detection device. The rolling motion and, additionally or alternatively, the pitching motion can indicate, for example, an uneven roadway or travel path on which the vehicle is traveling. Advantageously, the motion is transferred to the image detection device so that it will detect the rolling motion and, additionally or alternatively, the pitching motion. An “inertial detection device” can be understood as a device or a sensor that utilizes an inertia of the object connected to the device or the sensor and ascertains therefrom a motion trajectory of an object such as the vehicle. According to an embodiment, as a result of the detection step the comparison result can be checked, confirmed or corrected, or the reference map in that region can be updated. For example, by way of the rolling and/or pitching motion it is possible to ascertain whether the liquid depth that was ascertained while traveling through the liquid accumulation corresponds to the actual liquid depth, so that subsequent modifications to the bottom of the liquid accumulation which are not identifiable by an evaluation of the stored image can now be identified by way of the vehicle's motion as it travels through the liquid accumulation.

The example method according to the present invention may have a step of outputting a storage signal to an interface with the storage device, in order to add to the stored image a parameter representing the redetermined liquid depth. This means that, for example, the liquid may have changed and an actual liquid depth can now be ascertained and then associated with the stored image. Such a change can be, for example, a bottom that has been washed away. Advantageously, the redetermined liquid depth is added to the reference map or to the stored image so that a datum regarding current topography of the travel path or of the bottom of the liquid accumulation also exists in the stored image or in the reference map, even if the bottom, constituting a travel path through the liquid accumulation, is not directly identifiable by the image detection device.

When the vehicle pitches or rolls, i.e., drives through the puddle, the camera no longer sees this; in other words, from the path or trajectory that was traveled, it is possible to back-calculate as to which previous image (puddle) now pertains to the depth determined by pitching and/or rolling etc., and then to update it in the reference map. Since no image data of the puddle bottom are available, the bottom of the puddle can be generated in the reference map using “augmented reality” methods.

According to an example embodiment of the present invention, the method can encompass a step of furnishing a transmitted signal using the storage signal, in order to transmit to at least one further vehicle, and additionally or alternatively to a cloud unit, a parameter representing the redetermined liquid depth. A “cloud unit” can be understood, for example, as a vehicle-external computer network in which data can be distributed and/or fused between several computer units connected to the computer network. The further vehicle can be configured, for example, to transport persons and, additionally or alternatively, objects. It thereby advantageously becomes possible for the current map also to be updated in the further vehicle, so as thereby to propagate the information regarding the current liquid depth as efficiently as possible to at least one further travel path user.

According to an example embodiment of the present invention, in the ascertaining step the travel route can be ascertained using a vehicle geometry parameter of the vehicle, in particular the wheelbase and, additionally or alternatively, a ground clearance beneath the vehicle. This means that the vehicle geometry parameter represents, for example, the wheelbase and/or a permissible fording depth and, additionally or alternatively, the ground clearance between the ground and the lower edge of the vehicle. Advantageously, by taking into consideration the kinematics and dynamics of the vehicle, the travel trajectory can be selected in such a way that, for example, on the one hand a hazardous situation is avoided, and on the other hand a maximally direct travel path through the liquid accumulation can nevertheless be selected.

It is particularly advantageous if the example method includes a step of controlling the vehicle, in particular a steering unit, drive unit, and/or braking unit of the vehicle, depending on the ascertained liquid depth of the liquid accumulation and/or on the ascertained travel trajectory through the liquid accumulation. Preferably, control is applied to the vehicle in such a way that it automatically follows the ascertained travel trajectory. It is possible in this context for the speed of the vehicle to be limited automatically depending on the ascertained liquid depth of the liquid accumulation, in particular by way of a minimum and/or maximum speed along the ascertained travel trajectory. Hazardous situations resulting from the liquid accumulation can thereby be avoided automatically.

The example methods of the present invention can be implemented, for example, in software or hardware or in a mixed form of software and hardware, for example in a control device.

The present invention furthermore provides a control device that is embodied to carry out, control, or implement the steps of a variant of the method presented here in corresponding devices. This variant embodiment of the present invention in the form of a control device also allows the object on which the invention is based to be achieved quickly and efficiently.

The control device can have for that purpose at least one computation unit for processing signals or data, at least one storage unit for storing signals or data, at least one interface with a sensor or an actuator for reading in sensor signals from the sensor or for outputting control signals to the actuator, and/or at least one communication interface for reading in or outputting data that are embedded in a communication protocol. The computation unit can be, for example, a signal processor, a microcontroller, or the like, and the storage unit can be a flash memory, an EEPROM, or a magnetic storage unit. The communication interface can be embodied to read in or output data wirelessly or in wire-based fashion; a communication interface that can read in or output wire-based data can read in those data, for example, electrically or optically from a corresponding data transfer line, or output them onto a corresponding data transfer line.

A “control device” can be understood in the present case as an electrical device that processes sensor signals and, as a function thereof, outputs control signals and/or data signals. The control device can have an interface that can be embodied in hardware- and/or software-based fashion. With a hardware-based embodiment the interfaces can be, for example, part of a so-called system ASIC that contains a wide variety of functions of the control device. It is also possible, however, for the interfaces to be separate integrated circuits or to be made up at least in part of discrete components. With a software-based embodiment, the interfaces can be software modules that are present, for example, on a microcontroller in addition to other software modules.

In an advantageous embodiment of the present invention, the control device effects control of a method for ascertaining a liquid depth of a liquid accumulation on a travel path in front of a vehicle, and of a method for ascertaining a travel trajectory through a liquid accumulation on a travel path in front of a vehicle. The control device can access for that purpose, for example, sensor signals such as a reading-in signal and a comparison signal. Control application is effected via actuators such as a reading-in unit and a comparison unit.

Also advantageous is a computer program product or computer program having program code, which can be stored on a machine-readable medium or storage medium such as a semiconductor memory, a hard-drive memory, or an optical memory and can be used to carry out, implement, and/or control the steps of the method according to one of the embodiments described above, in particular when the program product or program is executed on a computer or an apparatus.

Exemplifying embodiments of the present invention are explained in further detail below and are depicted in the figures.

### BRIEF DESCRIPTION OF THE DRAWINGS

FIG. 1 schematically depicts a vehicle having a control device and a further control device according to an exemplifying embodiment of the present invention, and a further vehicle.

FIG. 2 is a side view of a vehicle on an uneven travel path having at least one liquid accumulation, in order to describe the manner of operation of an exemplifying embodiment of the present invention.

FIG. 3 depicts a rear side of a vehicle on an uneven travel path having at least one liquid accumulation, in order to describe the manner of operation of an exemplifying embodiment of the present invention.

FIG. 4 depicts a rear side of a vehicle on an uneven travel path having at least one liquid accumulation, in order to describe the manner of operation of an exemplifying embodiment of the present invention.

FIG. 5 is a flow chart of a method for ascertaining a liquid depth of a liquid accumulation on a travel path in front of a vehicle, and of a method for ascertaining a travel trajectory through the liquid accumulation on the travel path in front of the vehicle, in each case according to an exemplifying embodiment of the present invention.

### DETAILED DESCRIPTION OF EXAMPLE EMBODIMENTS

In the description below of favorable exemplifying embodiments of the present invention, identical or similar reference characters are used for elements that are depicted in the various Figures and function similarly, repeated description of those elements being omitted.

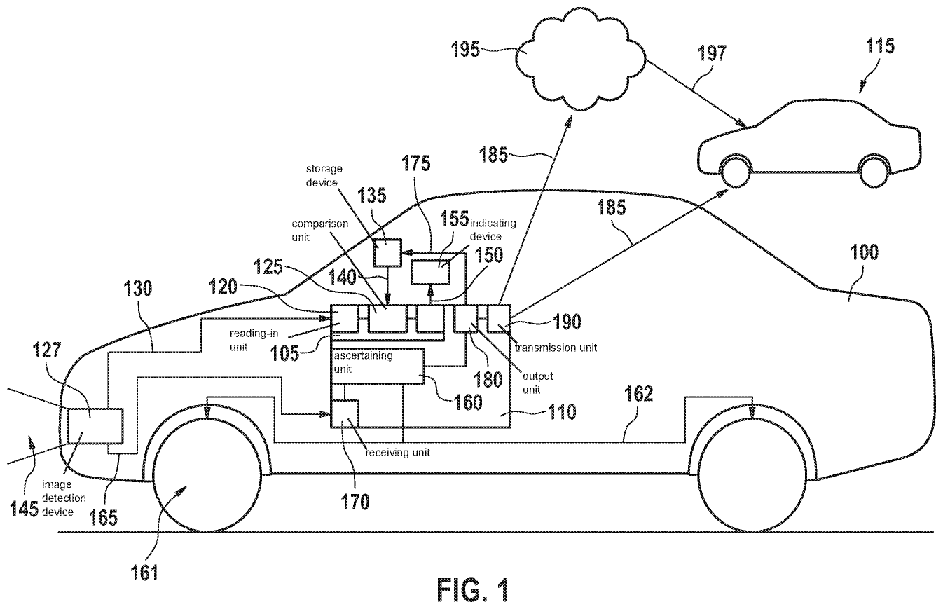

FIG. 1 schematically depicts a vehicle 100 having a control device 105 and a further control device 110, each according to an exemplifying embodiment of the present invention; and a further vehicle 115. According to this exemplifying embodiment, vehicle 100 is configured to transport persons and/or objects. This means that it can be implemented, for example, as a passenger car or as a commercial vehicle. Vehicle 100 has control device 105 and further control device 110. Control device 105 is embodied to carry out and/or control a method for ascertaining a liquid depth of a liquid accumulation on a travel path in front of vehicle 100. Control device 105 according to this exemplifying embodiment accordingly has a reading-in unit 120 and a comparison unit 125. Reading-in unit 120 is embodied to read in a current image 130 detected by an image detection device 127. Comparison unit 125 is embodied to compare current image 130 with an image 140 that is stored in a storage device 135 and represents a vehicle-external region 145 having no liquid accumulation, in order to obtain a comparison result that represents a liquid depth of the liquid accumulation. For example, a difference between a topographic elevation of a terrain on current image 130 and a topographic elevation of a terrain on stored image 140 can be determined, from which it is then evident that a ground depression in stored image 140 is not present in current image 130 and is thus to be understood to be filled with a liquid, with the result that the liquid accumulation is formed. Image detection device 127 can be implemented, for example as an (optical) camera.

Optional exemplifying embodiments of the present invention are described below:

Control device 105 can be embodied, for example, to furnish an indication signal 150 to an indicating device 155. According to this exemplifying embodiment, indication signal 150 represents an ascertained liquid depth of the liquid accumulation and/or a subsurface contour beneath a liquid accumulation surface. According to this exemplifying embodiment, indicating device 155 can be implemented as a (for example, touch-sensitive) display that is embodied to display information to a user, for example to the driver of vehicle 100.

Further control device 110 is embodied, according to this exemplifying embodiment, to execute or control a method for ascertaining a travel trajectory through the liquid accumulation on the travel path in front of vehicle 100. Further control device 110 has, for that purpose, control device 105 as well as an ascertaining unit 160 that is embodied to ascertain the travel trajectory and, according to this exemplifying embodiment, furnish it to, for example, a steering unit 161 via a steering signal 162. In steering unit 161, vehicle 100 can then be controlled or steered, using steering signal 162, in such a way that it travels along the ascertained travel trajectory.

According to a further exemplifying embodiment, further control device 110 can also receive or read in, via a receiving unit 170, a rolling motion and/or a pitching motion 165 detected by image detection device 127 (and/or an inertial detection device that is not explicitly depicted in FIG. 1) in order to plausibilize and/or redetermine the liquid depth of the liquid accumulation. Further control device 110 is furthermore embodied, for example, to output a storage signal 175, via an output unit 180, to an interface with storage device 135. Further control device 110 is furthermore embodied to transmit a transmitted signal 185 via a transmission unit 190, using storage signal 175, to further vehicle 115 and/or to a cloud unit 195. According to this exemplifying embodiment, cloud unit 195 can in turn output to further vehicle 115, for example, a forwarding signal 197 that, for example, represents the information conveyed from vehicle 100. Information regarding the current liquid depth of the liquid accumulation can thereby also be obtained in further vehicle 115 so that, for example, the corresponding information is available to a stored image or to the current map, and thus in further vehicle 115.

In other words, embodiments of the present invention makes it possible to repeatedly identify, for example on construction sites, in off-road environments, or in areas with heavy precipitation, for example in monsoon regions, ground surface regions that fill up to a very large extent with a liquid, for example water, so that, for example, large puddles, road inundations, fords, or even small lakes are produced. The present invention therefore provides a capability for puddle depth estimation and for ascertaining a reference map and a current map, for example respectively in the form of a semantic map, on which those corresponding depths can be noted. A method for predictive puddle identification and for correspondingly warning and/or notifying a driver as to a possible travel trajectory adapted to vehicle 100, which can also be referred to as “route guidance,” is developed or presented for that purpose.

The depth and thus the hazardousness of such puddles is not directly apparent to the driver of a road vehicle or off-road vehicle, for example a construction vehicle, and thus represents a possible potential hazard. The hazard potential can occur, for example, in the form of vehicle damage, vehicle 100 becoming stuck, or even in the form of an accident, since the vehicle may, for example, slide or tip over while traversing the liquid accumulation. According to an exemplifying embodiment, an attempt can be made, for example by trial and error, to manage the situation. Handling such situations is more difficult for highly automated vehicles 100 having no driver, since the driver's subjective driving feel (also referred to colloquially as “the seat of one's pants”) is absent.

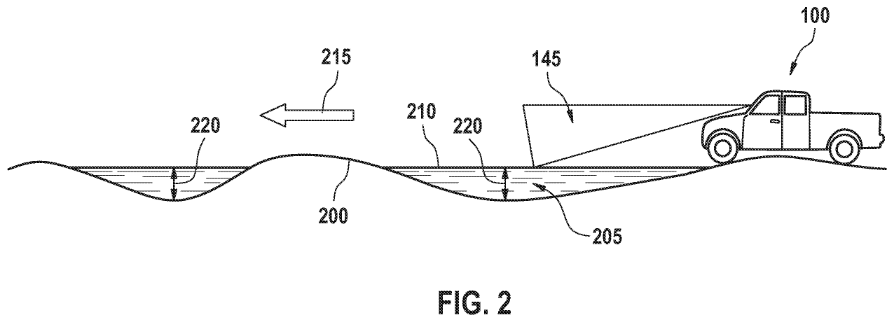

FIG. 2 is a side view of a vehicle 100 on an uneven travel path 200 having at least one liquid accumulation 205, in order to describe the manner of operation of an exemplifying embodiment of the present invention. According to an exemplifying embodiment, vehicle 100 depicted here can correspond to vehicle 100 described in FIG. 1. Liquid accumulation 205, which can occur, e.g., as a large puddle of water, is produced because of the uneven travel path 200 in front of vehicle 100. According to this exemplifying embodiment, vehicle 100 identifies, by way of image detection device 127 of FIG. 1, a liquid accumulation surface 210 of liquid accumulation 205 in vehicle-external region 145 that is located in front of vehicle 100 in travel direction 215. By way of a comparison of vehicle-external region 145 in a current state (from the current image) with a stored state (from the stored image or the reference map) it is possible to ascertain a liquid depth 220 that represents a deepest point of liquid accumulation 205 (i.e., the distance between liquid accumulation surface 210 and the bottom of liquid accumulation 205) and, according to this exemplifying embodiment, is referred to as “delta.”

In other words, according to this exemplifying embodiment of the present invention, liquid depth 220, which denotes the delta of the stored, or of a given, topography and a current identification while driving, is ascertained.

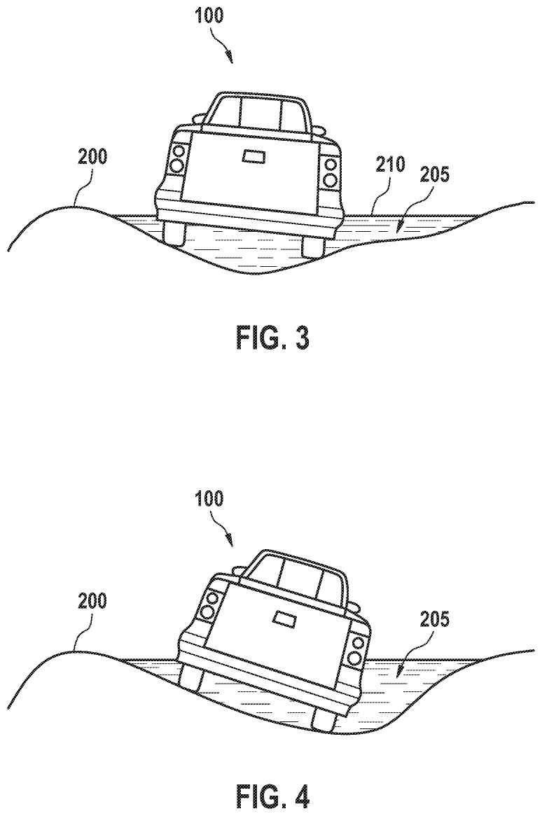

FIG. 3 depicts a rear side of a vehicle 100 on an uneven travel path 200 having at least one liquid accumulation 205, in order to describe the manner of operation of an exemplifying embodiment of the present invention. Vehicle 100 depicted here can correspond to vehicle 100 described in FIG. 2. According to this exemplifying embodiment, travel path 200 is at least partly covered by liquid accumulation 205, so that the travel path, or a subsurface beneath liquid accumulation surface 210, is concealed. According to this exemplifying embodiment, as a result of the unevenness of travel path 200, one side of vehicle 100 sits deeper in liquid accumulation 205 than another side of vehicle 100.

In other words, these depictions show an exemplifying embodiment in which a subsurface of a liquid accumulation is depicted upon, or after, a first passage by the vehicle through the liquid accumulation. This means that a tilt of vehicle 100 in the context of a predefined travel trajectory is defined or results in the context of passage, and can be detected, for example, by image detection device 127 of FIG. 1.

This means that by way of image detection device 127 of FIG. 1, a possibility exists for obtaining required depth information if, for example, the rolling or tilting behavior of vehicle 100 as it travels through liquid accumulation 205 is evaluated. According to this exemplifying embodiment, rolling motions and pitching motions of vehicle 100 take place as vehicle 100 travels through liquid accumulation 205, which is also regarded as an obstacle. Because the image detection device (and/or the inertial detection device) is installed in stationary fashion in vehicle 100, according to this exemplifying embodiment those rolling and pitching motions become transferred to an optical path, i.e., to image detection device 127 of FIG. 1 and/or to the inertial detection device. It is also possible, in this context, to take into account compensation for inherent motions in the images or in image processing, i.e., obtaining objects whenever possible always from the same perspective in which classifiers were also trained, so that classification functions as optimally as possible. If, for example, the subsurface or travel path 200 through the liquid then becomes severely stressed by the liquid and by being frequently traveled through, so that, for example, a trench beneath liquid accumulation surface 210 becomes intensified or further rutted out or washed out, this is then identified indirectly by way of image detection device 127, which can also be referred to as a camera system. According to this exemplifying embodiment, such a change in the subsurface, and thus in a possibly modified liquid depth, can be added to the stored image, or at least such information can be introduced by way of a modified liquid depth. According to this exemplifying embodiment, an addition to the stored image can also be made directly on the basis of the rolling and pitching motion by way of a sensor system, for example a tilt sensor and/or the inertial detection device.

According to an exemplifying embodiment, the present invention allows the vehicle to avoid both tipping over and becoming stuck in the liquid accumulation. If it is assumed, for example, that the driver maintains a current position of a steering system, or a planned travel trajectory through liquid accumulation 205, then depending on the travel trajectory a tilt of vehicle 100 in the driving direction and in a direction oriented transversely thereto can be predicted or determined. According to an exemplifying embodiment of the present invention, this involves in principle a search method for a favorable driving trajectory on which vehicle 100 will experience as little hazard as possible, for example a rolling tilt or pitching tilt that is as small as possible. Using a variety of vehicle parameters, for example a load carried by vehicle 100, a critical tilt angle in a travel direction and in a direction transverse thereto can be determined. According to an exemplifying embodiment, the travel trajectory can be shifted alongside the original one in an online simulation until a travel trajectory is discovered which has a non-critical tilt angle. Alternatively, based on the depth profile it is possible to label the travel path or travel trajectory that would result in a tipover. Proceeding from an open-space identification or an identification of travelable terrain, which results directly in a travel path limitation or obstacles in the terrain, a travel route which is in the vicinity of the original travel path 200, and which “just” does not cause a tipover, is selected. A horizon of the search method can be very short (for example, 5 meters in front of the vehicle) and, according to an exemplifying embodiment, can encompass a risk that vehicle 100 might follow a travel trajectory on which it cannot continue without a risk of tipping over. According to an exemplifying embodiment, vehicle 100 transitions onto a long horizon (e.g., max. 10 meters to the destination) that finds a suitable travel trajectory to the destination.

Based on previous journeys through liquid accumulation 205, according to an exemplifying embodiment, an indication as to grip and/or coefficients of friction of the ground beneath the liquid accumulation can be identified from existing vehicle parameters such as ESP information or wheel slip. For example, a difference calculated between a speed determination from a wheel rotation speed and from a radar or satellite-based localization system can indicate a slip. Coefficients of friction of the subsurface or of a wheel on the subsurface can furthermore be inferred, for example, from topographic maps and known properties of wet ground. According to an exemplifying embodiment, a kinetic energy of vehicle 100 (e.g., momentum) is then correlated with whether vehicle 100 can successfully traverse liquid accumulation 205. This means that a speed and vehicle mass of vehicle 100 can also be taken into account in order to allow prediction of a risk of getting stuck. According to an exemplifying embodiment, a recommendation can also be given to the driver of vehicle 100 to increase the speed (if that is possible, since some machinery has a top speed of only 20 km/h). According to a further exemplifying embodiment, if no data are available, for example, then a “black ice” situation (i.e., a very low coefficient of friction) in the region of liquid accumulation 205 can be assumed.

FIG. 4 depicts a rear side of a vehicle 100 on an uneven travel path 200 having at least one liquid accumulation 205, in order to describe the manner of operation of an exemplifying embodiment of the present invention. Vehicle 100 depicted here can correspond to the vehicle described in FIG. 3. Only travel path 200 is depicted slightly differently. Unlike what is depicted in FIG. 3, according to this exemplifying embodiment liquid accumulation 205 is deeper, which is attributable, for example, to erosion and/or removal of the subsurface, thus in turn increasing a risk of sinking in.

This depiction shows, for example, the exemplifying embodiment in which the subsurface has been dug into more deeply after being repeatedly traversed. This means that for a predefined travel trajectory, a greater tilt of vehicle 100 is to be expected.

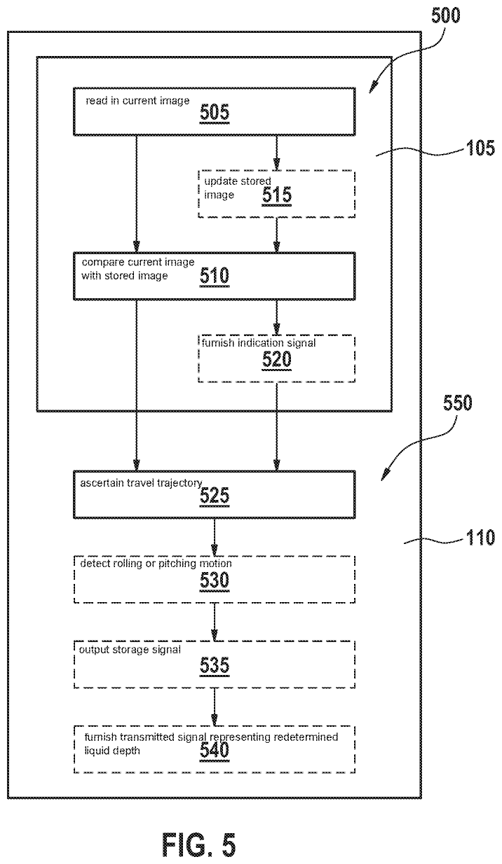

FIG. 5 is a flow chart of a method 500 for ascertaining a liquid depth of a liquid accumulation on a travel path in front of a vehicle, and of a method 550 for ascertaining a travel trajectory through the liquid accumulation on the travel path in front of the vehicle, according to an exemplifying embodiment. According to an exemplifying embodiment, methods 500 and 500 can be carried out in a vehicle such as the one described in FIGS. 1 to 4. According to this exemplifying embodiment, ascertaining method 500 is controlled or executed by units from control device 105. It encompasses a step 505 of reading in a current image, detected by an image detection device, of a vehicle-external region in which an identified liquid accumulation is present, and a step 510 of comparing the current image with the image, stored in the storage device, which represents the vehicle-external region without a liquid accumulation, in order to obtain a comparison result that represents the liquid depth of the liquid accumulation (for example, as a difference between the current image and the stored image).

In other words, according to an exemplifying embodiment, in comparing step 510 a comparison is carried out between an identified topographic elevation of the travel path from the current image and an identified topographic elevation of the travel path from the stored image, in order to ascertain the liquid depth. According to this exemplifying embodiment, in comparing step 510 a depth profile of the travel path in the region of the liquid accumulation is also ascertained.

According to this exemplifying embodiment, method 500 furthermore encompasses a step 515 of updating the stored image in the storage device. According to this exemplifying embodiment, updating step 515 is performed, for example, at least once a day or, for example, also every hour and/or as a function of weather, for instance if major changes in the liquid depth can be expected, for example in a region in which monsoon rains occur. Method 500 furthermore encompasses a step 520 of furnishing an indication signal, to be outputted to the indicating device, which represents the ascertained liquid depth of the liquid accumulation and/or a subsurface contour beneath a liquid accumulation surface.

Method 550 for ascertaining a travel trajectory through the liquid accumulation on the travel path in front of the vehicle encompasses, according to this exemplifying embodiment, steps 505, 510, 515, 520 of method 500, and an ascertaining step 525. In ascertaining step 525, the travel trajectory of the vehicle is ascertained using the liquid depth of the liquid accumulation. The travel trajectory represents a travel route through the liquid accumulation.

in other words, according to an exemplifying embodiment, for example, in ascertaining step 525 the travel route is ascertained using a vehicle geometry parameter of the vehicle, in particular the wheelbase and/or a permissible fording depth and/or a ground clearance beneath the vehicle. Method 550 furthermore encompasses a step 530 of detecting at least one rolling motion and/or pitching motion of the vehicle in order to plausibilize or redetermine the liquid depth of the liquid accumulation. According to this exemplifying embodiment, the pitching motion and/or the rolling motion is detected by an image detection device. Method 550 furthermore encompasses a step 535 of outputting a storage signal to an interface with the storage device, in order to add the parameter representing the redetermined liquid depth to the stored image. For this, at least the path traveled (or the depth profile of the path traveled) could be updated in the image, for instance using augmented reality. In a step 540 of furnishing a transmitted signal using the storage signal, according to this exemplifying embodiment a parameter representing the redetermined liquid depth is transmitted to at least one further vehicle and/or to a cloud unit.

In other words, for example, a topographic reference to which the vehicle can orient itself is presumed to exist (for example, by reconciliation or delta ascertainment). According to an exemplifying embodiment, the vehicle likewise has onboard high-resolution maps that can be made available, for example, constantly and with daily updates. When the vehicle arrives in an area having liquid accumulations, a delta datum is created from the existing map material, which was prepared under “good” conditions (i.e., with no liquid accumulations) and from the actual identification based on the current image. This delta datum represents the liquid depth. Based on the delta datum, the travel trajectory on which optimum passage through the liquid accumulation is made possible can be proposed to the driver. According to an exemplifying embodiment, this can be regarded as driver assistance. The ascertained liquid depth, and a contour beneath the liquid accumulation surface, can be displayed to the driver on the indicating device. According to this exemplifying embodiment, a further improvement occurs as a result of knowledge of a vehicle geometry, which can also be referred to as a vehicle geometry parameter, for example a wheelbase and/or a permissible fording depth and/or a ground clearance beneath the vehicle.

Numerous data that are important for further vehicles on the same path segment are stored within the storage device. This relates principally, but not exclusively, to highly automated vehicles. According to an exemplifying embodiment, these data contain information regarding the following questions: How often has this path segment having the puddle been traveled along by vehicles? Which types of vehicle have traveled along this path segment? Do indicators exist for passage problems that are attributable, for example, to a slick roadway and/or a high engine load (howling, high engine speed, and or vehicle stall)? Has a further vehicle become stuck in the liquid accumulation? According to an exemplifying embodiment, such information is stored directly. According to an alternative exemplifying embodiment, in such a case the travel route can be blocked.

If an exemplifying embodiment encompasses an “and/or” relationship between a first feature and a second feature, this is to be read to mean that the exemplifying embodiment according to one embodiment has both the first feature and the second feature, and according to a further embodiment has either only the first feature or only the second feature.

What is claimed is:

1. A method for ascertaining a liquid depth of a liquid accumulation on a travel path of a vehicle in front of the vehicle, the method comprising the following steps:
reading in a current image of a vehicle-external region of the travel path, detected by an image detection device of the vehicle, in which the liquid accumulation is present; and
ascertaining the liquid depth of the liquid accumulation by comparing the current image with an image that is stored in a storage device and represents the vehicle-external region without the liquid accumulation.

2. The method as recited in claim 1, further comprising the following step:
updating the stored image in the storage device earlier in time than the comparing step, the updating step being performed at least once a day and/or in weather-dependent fashion.

3. The method as recited in claim 1, wherein, in the comparing step, a comparison is carried out between an identified topographic elevation of the travel path and/or a liquid accumulation surface from the current image, and an identified topographic elevation of the travel path and/or of the liquid accumulation surface from the stored image, to ascertain the liquid depth.

4. The method as reciting in claim 1, wherein, in the comparing step, a depth profile of the travel path in a region of the liquid accumulation is ascertained.

5. The method as recited in claim 1, further comprising the following step:
furnishing an indication signal to be outputted to an indicating device of the vehicle, the indication signal representing the ascertained liquid depth of the liquid accumulation and/or a subsurface contour beneath a liquid accumulation surface.

6. A method for ascertaining a travel trajectory through a liquid accumulation on a travel path in front of a vehicle, the method comprising the following steps:
reading in a current image of a vehicle-external region of the travel path, detected by an image detection device of the vehicle, in which the liquid accumulation is present; and
ascertaining the liquid depth of the liquid accumulation by comparing the current image with an image that is stored in a storage device and represents the vehicle-external region without a liquid accumulation; and
ascertaining the travel trajectory of the vehicle, which represents a travel route through the liquid accumulation, using the ascertained liquid depth of the liquid accumulation.

7. The method as recited in claim 6, further comprising the following step:
detecting at least one rolling motion and/or pitching motion of the vehicle upon passage through the liquid accumulation to plausibilize and/or redetermine the liquid depth of the liquid accumulation, the pitching motion and/or the rolling motion being detected by an image detection device and/or an inertial detection device.

8. The method as recited in claim 7, further comprising the following step:
outputting a storage signal to an interface with the storage device to add to the stored image a parameter representing the redetermined liquid depth.

9. The method as recited in claim 8, further comprising the following step:
furnishing a transmitted signal using the storage signal to transmit, to at least one further vehicle and/or to a cloud unit, a parameter representing the redetermined liquid depth.

10. The method as recited in claim 6, wherein he travel route being ascertained, in the ascertaining the travel trajectory step, using a vehicle geometry parameter of the vehicle, the vehicle geometry parameter including a wheelbase of vehicle, and/or a permissible fording depth, and/or a ground clearance beneath the vehicle.

11. The method as recited in claim 1, further comprising the following step:
controlling, a steering unit of the vehicle, and/or a drive unit of the vehicle, and/or a braking unit of the vehicle, depending on the ascertained liquid depth of the liquid accumulation.

12. The method as recited in claim 6, further comprising the following step:
controlling, a steering unit of the vehicle, and/or a drive unit of the vehicle, and/or a braking unit of the vehicle, depending on: (i) the ascertained liquid depth of the liquid accumulation, and/or (ii) the ascertained travel trajectory through the liquid accumulation.

13. A control device configured to ascertain a liquid depth of a liquid accumulation on a travel path of a vehicle in front of the vehicle, the control unit configured to:
read in a current image of a vehicle-external region of the travel path, detected by an image detection device of the vehicle, in which the liquid accumulation is present; and
ascertain the liquid depth of the liquid accumulation by comparing the current image with an image that is stored in a storage device and represents the vehicle-external region without a liquid accumulation.

14. A non-transitory machine-readable storage medium on which is stored a computer program for ascertaining a liquid depth of a liquid accumulation on a travel path of a vehicle in front of the vehicle, the computer program, when executed by a control unit, causing the control unit to perform the following steps:
reading in a current image of a vehicle-external region of the travel path, detected by an image detection device of the vehicle, in which the liquid accumulation is present; and
ascertaining the liquid depth of the liquid accumulation by comparing the current image with an image that is stored in a storage device and represents the vehicle-external region without a liquid accumulation.
